(19) United States
(12) Patent Application Publication
(10) Pub. No.: US 2003/0093555 A1
(43) Pub. Date: May 15, 2003

(54) Method, apparatus and system for routing messages within a packet operating system

(76) Inventors: William Paul Harding-Jones, Bracknell (GB); Arthur Berggreen, Santa Barbara, CA (US)

Correspondence Address: GARDERE WYNNE SEWELL LLP, 1601 Elm Street, Suite 3000, Dallas, TX, 75201-4767, US

(21) Appl. No.: 10/045,205

(22) Filed: Nov. 9, 2001

(51) Int. Cl. G06F 15/173; G06F 15/16

(52) U.S. Cl. 709/238; 709/236

(57) ABSTRACT

The present invention provides a method, apparatus and system for routing a message to a function instance within a packet operating system by receiving the message and requesting a destination address (label) for the function instance from a local repository. Whenever the destination address (label) is local, the message is sent to the function instance. Whenever the destination address (label) is remote, the message is packaged with the destination address (label) and the packaged message is sent to the function instance. Whenever the destination address (label) is not found, the destination address (label) for the function instance is requested from a remote repository, the message is then packaged with the destination address (label) and the packaged message is sent to the function instance. This method can be implemented using a computer program with various code segments to implement the steps of the method.

### TECHNICAL FIELD OF THE INVENTION

The present invention relates generally to the field of communications and, more particularly, to a method, apparatus and system for routing messages within a packet operating system.

### BACKGROUND OF THE INVENTION

The increasing demand for data communications has fostered the development of techniques that provide more cost-effective and efficient means of using communication networks to handle more information and new types of information. One such technique is to segment the information, which may be a voice or data communication, into packets. A packet is typically a group of binary digits, including at least data and control information. Integrated packet networks (typically fast packet networks) are generally used to carry at least two (2) classes of traffic, which may include, for example, constant bit-rate (“CBR”), speech (“Packet Voice”), data (“Framed Data”), image, and so forth. A packet network comprises packet devices that source, sink and/or forward protocol packets. Each packet has a well-defined format and consists of one or more packet headers and some data. The header contains information that gives control and address information, such as the source and destination of the packet.

A single packet device may source, sink or forward protocol packets. The elements (software or hardware) that provide the packet processing within the packet operating system are known as function instances. Function instances are combined together to provide the appropriate stack instances to source, sink and forward the packets within the device. Routing of packets or messages to the proper function instance for processing is limited by the capacity of central processing units (“CPU”), hardware forwarding devices or interconnect switching capacity within the packet device. Such processing constraints cause congestion and Quality of Service (“QoS”) problems inside the packet device.

The packet device may require the management of complex dynamic protocol stacks, which may be within any one layer in the protocol stack, or may be due to a large number of (potentially embedded) stack layers. In addition, the packet device may need instances of the stack to be created and torn down very frequently according to some control protocol. The packet device may also need to partition functionality into multiple virtual devices within the single physical unit to provide virtual private network services. For example, the packet device may need to provide many hundreds of thousands of stack instances and/or many thousands of virtual devices. Accordingly, there is a need for method, apparatus and system for routing messages within a packet operating system that improves system performance and reliability, is easy to operate and maintain, and provides scalability, virtualization and distributed forwarding capability with service differentiation.

### SUMMARY OF THE INVENTION

The method, apparatus and system for routing messages within a packet operating system in accordance with the present invention provides a common environment/executive for packet processing applications and devices. The present invention improves system performance and reliability, is easy to operate and maintain, and provides scalability, virtualization, service differentiation and distributed forwarding capability. High performance is provided by using a zero-copy messaging system, flexible message queues and distributing functionality to multiple processors on all boards, not just to ingress/egress boards. Reliability is improved by the redundancy, fault tolerance, stability and availability of the system. Operation and maintenance of the system is easier because dynamic stack management is provided, hardware modules are removable and replaceable during run-time. Redundancy can be provided by hot-standby control cards and non-revertive redundancy for ingress/egress cards.

The system also allows for non-intrusive software upgrades, non-SNMP management capability, complex queries, subtables and filtering capabilities, and group management, network-wide policy and QoS measures. Scalability is provided by supporting hundreds or thousands of virtual private networks (“VPN”), increasing port density, allowing multicasting and providing a load-sharing architecture. Virtualization is provided by having multiple virtual devices within a single physical system to provide VPN services wherein the virtual devices “share” system resources potentially according to a managed policy. The virtualization extends throughout the packet device including virtual-device aware management. Distributed forwarding capability potentially relieves the backplane and is scalable for software processing of complex stacks and for addition of multiple processors, I/O cards and chassis. As a result, the present invention reduces congestion, distributes processing, improves QoS, increases throughput and contributes to the overall system efficiency. The invention also includes a scheme where the order of work within the packet device is controlled via the contents of the data of the packets being processed and the relative priority of the device they are in, rather than by the function that is being done on the packet.

The packet operating system assigns a label or destination addresses to each function instance. The label is a position independent addressing scheme for function instances that allows for scalability up to 100,000's of function instances. The packet operating system uses these labels to route messages to the destination function instance. The unit of work of the packet operating system is the processing of a message by a function instance—a message may be part of the data path (packets to be forwarded by a software forwarder or exception path packets from a hardware forwarder) or the control path.

The present invention provides a method for routing a message to a function instance by receiving the message and requesting a destination address (label) for the function instance from a local repository. Whenever the destination address (label) is local, the message is sent to the function instance. More specifically, the message is sent to a local dispatcher for VPN aware and message priority based queueing to the function instance. Whenever the destination address (label) is remote, the message is packaged with the destination address (label) and the packaged message is sent to the destination node over the messaging fabric. Whenever the destination address (label) is not found, the destination address (label) for the function instance is requested from a remote repository, the message is then packaged with the destination address (label) and the packaged message is sent to the function instance. More specifically, the packaged message is sent to the destination node over the messaging fabric for ultimate delivery to the function instance. This method can be implemented using a computer program with various code segments to implement the steps of the method.

The present invention also provides an apparatus for routing a message to a function instance that includes a local repository and a messaging agent communicably coupled to the local repository. The messaging agent receives the message and requests a destination address (label) for the function instance from the local repository. Whenever the destination address (label) is local, the messaging agent sends the message to the function instance. More specifically, the message is sent to a local dispatcher for VPN aware and message priority based queueing to the function instance. Whenever the destination address (label) is remote, the messaging agent packages the message with the destination address (label) and sends the packaged message to the function instance. More specifically, the packaged message is sent to the destination node over the messaging fabric for ultimate delivery to the function instance. Whenever the destination address (label) is not found, the messaging agent requests the destination address (label) for the function instance from a remote repository, packages the message with the requested destination address (label) and sends the packaged message to the function instance.

In addition, the present invention provides a system for routing a message to a function instance that includes a system label manager, a system label repository communicably coupled to the system label manager, one or more messaging agents communicably coupled to the system label manager, and a repository communicably coupled to each of the one or more messaging agents. Each messaging agent is capable of receiving the message and requesting a destination address (label) for the function instance from the repository. Whenever the destination address (label) is local, the messaging agent sends the message to the function instance. More specifically, the message is sent to a local dispatcher for VPN aware and message priority based queueing to the function instance. Whenever the destination address (label) is remote, the messaging agent packages the message with the destination address (label) and sends the packaged message to the function instance. More specifically, the packaged message is sent to the destination node over the messaging fabric for ultimate delivery to the function instance. Whenever the destination address (label) is not found, the messaging agent requests the destination address (label) for the function instance from the system label manager, packages the message with the requested destination address (label) and sends the packaged message to the function instance.

Other features and advantages of the present invention shall be apparent to those of ordinary skill in the art upon reference to the following detailed description taken in conjunction with the accompanying drawings.

### BRIEF DESCRIPTION OF THE DRAWINGS

For a better understanding of the invention, and to show by way of example how the same may be carried into effect, reference is now made to the detailed description of the invention along with the accompanying figures in which corresponding numerals in the different figures refer to corresponding parts and in which:

FIG. 1 is a block diagram of a network of various packet devices in accordance with the present invention;

FIG. 2 is a block diagram of two packet network devices in accordance with the present invention;

FIG. 3 is a block diagram of a packet operating system in accordance with the present invention;

FIG. 4 is a block diagram of a local level of a packet operating system in accordance with the present invention;

FIG. 5 is a flow chart illustrating the operation of a message routing process in accordance with the present invention; and

FIG. 6 is a flow chart illustrating the creation of a new function instance in accordance with the present invention.

### DETAILED DESCRIPTION OF THE INVENTION

While the making and using of various embodiments of the present invention are discussed in detail below, it should be appreciated that the present invention provides many applicable inventive concepts, which can be embodied in a wide variety of specific contexts. For example, in addition to telecommunications systems, the present invention may be applicable to other forms of communications or general data processing. Other forms of communications may include communications between networks, communications via satellite, or any form of communications not yet known to man as of the date of the present invention. The specific embodiments discussed herein are merely illustrative of specific ways to make and use the invention and do not limit the scope of the invention.

The method, apparatus and system for routing messages within a packet operating system in accordance with the present invention provides a common environment/executive for packet processing applications and devices. The present invention improves system performance and reliability, is easy to operate and maintain, and provides scalability, virtualization, service differentiation and distributed forwarding capability. High performance is provided by using a zero-copy messaging system, flexible message queues and distributing functionality to multiple processors on all boards, not just to ingress/egress boards. Reliability is improved by the redundancy, fault tolerance, stability and availability of the system. Operation and maintenance of the system is easier because dynamic stack management is provided, hardware modules are removable and replaceable during run-time. Redundancy can be provided by hot-standby control cards and non-revertive redundancy for ingress/egress cards.

The system also allows for non-intrusive software upgrades, non-SNMP management capability, complex queries, subtables and filtering capabilities, and group management, network-wide policy and QoS measures. Scalability is provided by supporting hundreds or thousands of virtual private networks (“VPN”), increasing port density, allowing multicasting and providing a load-sharing architecture. Virtualization is provided by having multiple virtual devices within a single physical system to provide VPN services wherein the virtual devices “share” system resources potentially according to a managed policy. The virtualization extends throughout the packet device including virtual-device aware management. Distributed forwarding capability potentially relieves the backplane and is scalable for software processing of complex stacks and for addition of multiple processors, I/O cards and chassis. As a result, the present invention reduces congestion, distributes processing, improves QoS, increases throughput and contributes to the overall system efficiency. The invention also includes a scheme where the order of work within the packet device is controlled via the contents of the data of the packets being processed and the relative priority of the device they are in, rather than by the function that is being done on the packet.

The packet operating system assigns a label or destination addresses to each function instance. The label is a position independent addressing scheme for function instances that allows for scalability up to 100,000's of function instances. The packet operating system uses these labels to route messages to the destination function instance. The unit of work of the packet operating system is the processing of a message by a function instance—a message may be part of the data path (packets to be forwarded by a software forwarder or exception path packets from a hardware forwarder) or the control path.

The present invention can be implemented within a single packet device or within a network of packet devices. As a result, the packet operating system of the present invention is scalable such the scope of a single packet operating system domain extends beyond the bounds of a traditional single embedded system. For example, FIG. 1 depicts a block diagram of a network 100 of various packet devices in accordance with the present invention is shown. Network 100 includes packet devices 102, 104 and 106, networks 108, 110 and 112, and packet operating system 114. As shown, packet device 102 handles packetized messages, or packets, between networks 108 and 110. Packet device 104 handles packets between networks 108 and 112. Packet device 106 handles packets between networks 110 and 112. Packet devices 102, 104 and 106 are interconnected with a messaging fabric 116, which is any interconnect technology that allows the transfer of packets. Packet devices 102, 104 and 106 can be device that source, sink and/or forward protocol packets, such as routers, bridges, packet switches, media gateways, network access servers, protocol gateways, firewalls, tunnel access clients, tunnel servers and mobile packet service nodes.

The packet operating system 114 includes a collection of nodes that cooperate to provide a single logical network entity (potentially containing many virtual devices). To the outside world, the packet operating system 114 appears as a single device that interconnects ingress and egress network interfaces. Each node is an addressable entity on the interconnect system, which may comprise of a messaging fabric for a simple distributed embedded system (such as a backplane), a complex of individual messaging fabrics, or several distributed embedded systems (each with their own backplane) connected together with some other technology (such as fast Ethernet). Each node has an instance of a messaging agent, also called a node messaging agent (“NMA”), that implements the transport of messages to local and remote entities (applications). The packet operating system 114 physically operates on each of packet devices or chassis 102, 104 or 106, which provide the physical environment (power, mounting, high-speed local interconnect, etc.) for the one or more nodes.

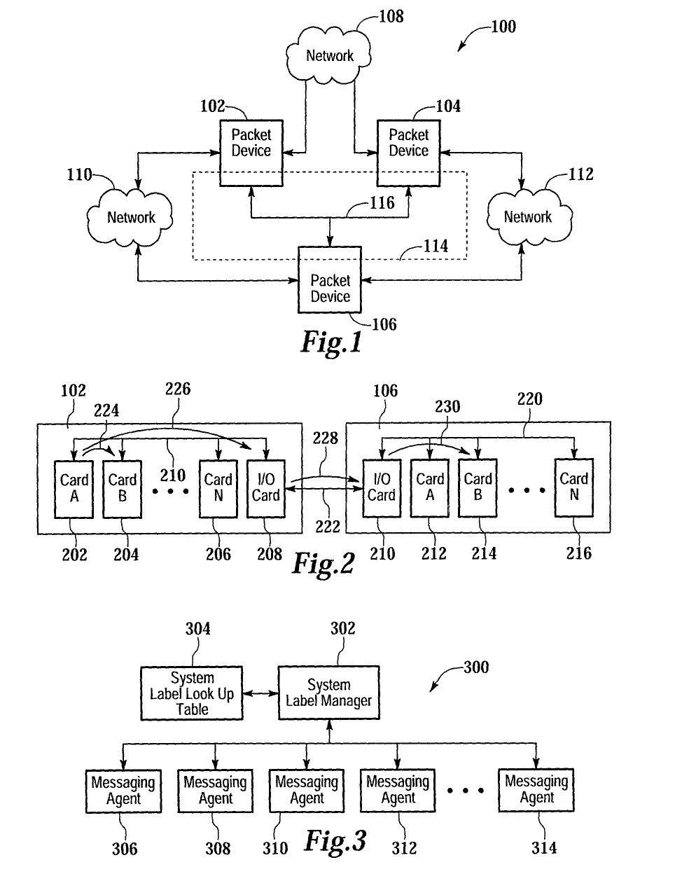

Referring now to FIG. 2, a block diagram of two packet network devices 102 and 106 in accordance with the present invention is shown. Packet device 102 includes card A 202, card B 204, card N 206, I/O card 208 and an internal communications bus 210. Similarly, packet device 106 includes card A 212, card B 214, card N 216, I/O card 218 and an internal communications bus 220. Cards 202, 204, 206, 212, 214 and 216 are any physical or logical processing environments having function instances that transmit and/or receive local or remote messages. Packet devices 102 and 106 are communicably coupled together via I/O cards 208 and 218 and communication link 222. Communication link 222 can be a local or wide area network, such as an Ethernet connection. Communication link 222 is equivalent to messaging fabric 116 (FIG. 1).

For example, card A 202 can have many messages that do not leave card A 202 and are processed locally by function instances with card A 202. Card A 202 can also send messages to other cards within the same packet device 102, such as card B 204 or card C 206. Line 224 illustrates a message being sent from card A 202 to card B 204 via internal communication bus 210. Moreover, card A 202 can send messages to cards within other packet devices, such as packet device 106. In such a case, card A 202 sends a message from card A 202 (packet device 102) to card B 214 (packet device 106) by sending the message to I/O card 208 (packet device 102) via internal communication bus 210 (packet device 102), as illustrated by line 226. I/O card 208 (packet device 102) then sends the message to I/O card 218 (packet device 106) via communication link 222, as illustrated by line 228. I/O card 218 (packet device 106) then sends the message to card B 214 (packet device 106) via communication bus 220 (packet device 106), as illustrated by line 230.

The packet operating system 114 (FIG. 1) includes one or more system control modules (“SCM”) communicably coupled to one or more network interface modules (“NIM”). The SCM implements the management of any centralized function such as initiation of system initialization, core components of network management, routing protocols, call routing, etc. The system label manager is also resident on the SCM. There may be a primary and secondary SCM for redundancy purposes and its functionality may evolve into a multi-chassis environment. The NIM connects to the communication interfaces to the outside world and implements interface hardware specific components, as well as most of the protocol stacks necessary for normal packet processing. The packet operating system 114 (FIG. 1) may also include a special processing module (“SPM”), which is a specialized board that implements encryption, compression, etc. (possibly in hardware). Each NIM and SCM has zero or more distributed forwarding engines (“DFE”). A DFE may be implemented in software or may include hardware assist. A central routing engine (“CRE”), which is typically resident in the SCM, is responsible for routing table maintenance and lookups. The CRE or system label manager may also use a hardware assist. DFEs from both NIM and SCM consult to CRE for routing decisions, which may be cached locally on the NIMs.

The SCM may also include a resource broker, which is a service that registers, allocates and tracks system-wide resources of a given type. Entities that need a resource ask the resource broker for allocation of that resource. Entities may tell the resource broker how long they need the resource for. Based on the information provided by the client, the location of the client and resource, the capacity and current load of the resource, the resource broker allocates the resource for the client and returns a label to the client. The client notifies the resource broker when it is “done” with that resource. A resource may need to be allocated exclusively (e.g. a DSP) or may be shared (e.g. encryption sub-system). The resource broker service is provided on a per-VPN basis.

The present invention provides dynamic hardware management because the SCM keeps track of the configuration on the I/O cards and views the entire system configuration. As a result, board initialization is configuration independent. Configuration is applied as a dynamic change at the initialized state. There is no difference between initialization time configuration processing and dynamic reconfiguration. When a new board is inserted configuration processing for the new board does not affect the operation of the already running components. Moreover, when hardware is removed, the SCM can still keep a copy of the hardware's configuration in case it is replaced.

Now referring to FIG. 3, a block diagram of a packet operating system 300 in accordance with the present invention is shown. The packet operating system 300 includes a system label manager 302, a system label repository or look up table 304 and one or more messaging agents 306, 308, 310, 312 and 314 (these messaging agents may correspond to any of the nodes 202, 204, 206, 208, 210, 212, 213, 216 in FIG. 2). The system label manager 302 responds to label lookup requests, handles label registrations and unregistrations. In addition, the system label manager 302 maintains the unicast and multicast label databases typically located in the SCM. The unicast and multicast databases are collectively referred to as the system label repository or look up table 304, which can be a database or any other means of storing the labels and their associated destination addresses (labels). The unicast label database is a database of labels, their locations (node) in the system, associated attributes and flags. The multicast label database is a database of multicast labels, where each multicast label consists of a list of member unicast labels.

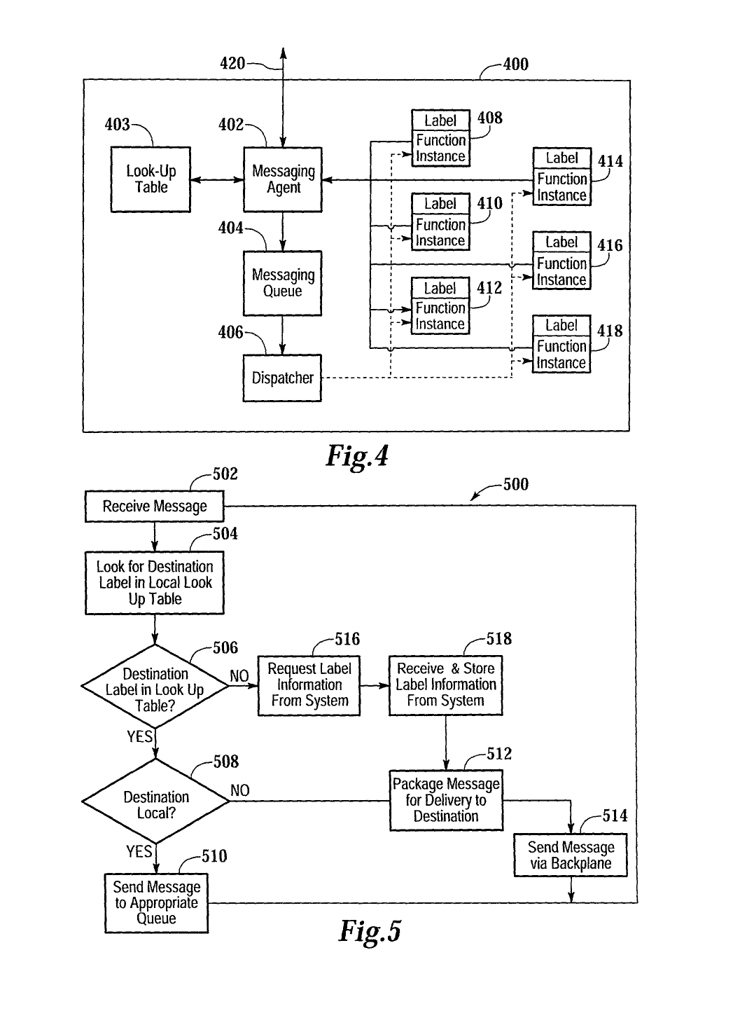

Messaging agents 306, 308, 310, 312 and 314, also referred to as node messaging agents, can be local (same packet device) or remote (different packet device) to the system label manager 302. Moreover, messaging agents 306, 308, 310, 312 and 314 can be local (same packet device) or remote (different packet device) to one another. The messaging agents 306, 308, 310, 312 and 314 (“NMA”) are the service that maintains the node local unicast and multicast label delivery databases, the node topology database and the multicast label membership database, collectively referred to as a local repository or look up table (See FIG. 4, look up table 403).

The present invention efficiently routes messages from one function instance to another regardless of the physical location of the destination function instance. Function instances and labels are an instantiation of some function and its state. Each function instance has a thread of execution that operates on that state to implement the protocol. Each function instance has a membership in a particular VPN partition. Each function instance is associated with a globally unique and centrally assigned identifier called a label. Labels facilitate effective and efficient addressing of function instances throughout the system and promote relocation of services throughout the system. Function instances communicate with one another by directing messages to these labels. The present invention also allows message multicasting, such that a multicast packet destined for two or more different NIMs is broadcast over the message fabric so that it is only sent once (if the fabric supports such an operation). Each NIM does its own duplication for its local interfaces. Moreover, well-known system services are also assigned labels. As a result, these services can be relocated in the system by just changing the decision tables to reflect their current location in the system.

The present invention uses a distributed messaging service to provide the communication infrastructure for the applications and thus hide the system (chassis/node) topology from the applications. The distributed messaging service is composed of a set of messaging agents 302 (on each node) and one system label manager 304 (on the SCM). The applications use a node messaging interface to access the distributed messaging service. Most of the distributed messaging service is implemented as library calls that execute in calling application's context. A node messaging task, which is the task portion of the distributed messaging service, handles the non-library portion of the distributed messaging service (e.g. reliable delivery retries, label lookups, etc.).

The distributed messaging service uses a four-layer protocol architecture:

| Layer | Peers | Analogy | Addressing |
|---|---|---|---|
| 4 | Application to Application | Application | src/dst labels |
| | | (DNS @) | |
| 3 | Messaging agent to Messaging agent | IP (IP @) | src/dst node address |
| 2 | Driver to Driver | MAC (IEEE @) | src/dst next Hop address |

| | |
|---|---|
| 1 | Physical |

Moreover, the present invention uses a variable length common system message block for communication between any two entities in the system. The system message block can be used for both control transactions and packet buffers. The format for the system message block is shown below:

*next
*prev
version_number
Transaction primitive
Source_label
dest_label
VR_context
QoS_info
handle
fn_index
Packet_data_length
*io_segments
Transaction_data_ext_size
Transaction_data
. . .
. . .
. . .
. . .

The system message block also includes a confirmation bit. An inter-node routing header prefixes the system label manager and contains information about how this message should be routed in the system of inter-connected nodes.

The *io_segments are pointers to a chained list of I/O segments that represent the data (user datagrams) that transmit through the node and the data generated or consumed by the node (e.g., routing updates, management commands, etc.). Moreover, the I/O segments include a segment descriptor (ios_hdr) and a data segment (ios_data). The I/O segments are formatted as follows:

next
prev
. . .
bfr_start
data_start
data_end
bfr_end
(debug fields)

The bfr_start is the area used by the backplane driver header and the inter-node routing header. The data_start points to the beginning of the system message block and the data_end points to the end of the system message block.

Reliable messages are acknowledged at the messaging agent layer using the message type field. The messaging agent generates an asynchronous “delivery failure” message if all delivery attempts have failed. Control messages will typically require acknowledgments, but not the data. Sequence number sets and history windows are used to detect duplicate unicast messages and looping multicast messages.

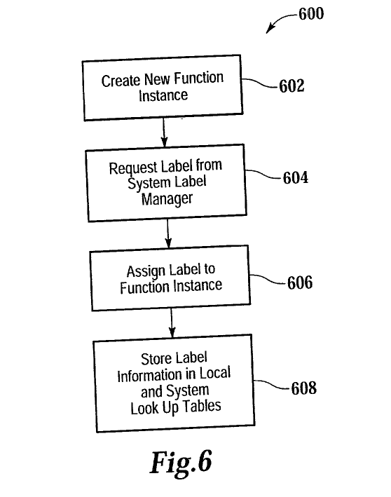

When new function instances are created, the system label manager 302 creates a unique label for the function instance and stores the label along with the destination address (label) of the function instance in the system label look up table 304. The system label manager 302 also sends the unique label and the destination address (label) for the function instance to the messaging agent 306, 308, 310, 312 or 314 that will handle messages for the function instance. The messaging agent 306, 308, 310, 312 or 314 stores the label along with the destination address (label) of the function instance in its local look up table. This process is also described in reference to FIG. 6. The system label manager 302 also receives requests for destination addresses (labels) from the messaging agents 306, 308, 310, 312 and 314. In such a case, the system label manager retrieves the destination address (label) for the requested label from the system label look up table 304 and sends the destination address (label) for the function instance to the requesting messaging agent 306, 308, 310, 312 or 314. The messaging agent 306, 308, 310, 312 or 314 stores the label along with the destination address (label) of the function instance in its local look up table. Whenever a label is destroyed, the system label manager 302 will either (1) notify all messaging agents 306, 308, 310, 312 and 314 that the label has been destroyed, or (2) keep a list of all messaging agents 306, 308, 310, 312 or 314 that have requested the destination address (label) for the destroyed label and only notify the listed messaging agents 306, 308, 310, 312 or 314 that the label has been destroyed.

Referring now to FIG. 4, a block diagram of a local level 400 of a packet operating system in accordance with the present invention is shown. The cards as mentioned in reference to FIG. 2, can include one or more local levels 400 of the packet operating system. For example, local level 400 can be allocated to a processor, such as a central processing unit on a control card, or a digital signal processor within an array of digital signal processors on a call processing card, or to the array of digital signal processors as a whole. The local level 400 includes a messaging agent 402, a local repository or look up table 403, a messaging queue 404, a dispatcher 406, one or more function instances 408, 410, 412, 414, 416 and 418, and a communication link 420 to the system label manager 302 (FIG. 3) and other dispatching agents. Look up table 403 can be a database or any other means of storing the labels and their associated destination addresses (labels). Note that multiple messaging queues 404 and dispatchers 406 can be used. Note also that each function instance 408, 410, 412, 414, 416 and 418 includes a label. The messaging agent 402 receives local messages from function instances 408, 410, 412, 414, 416 and 418, and remote messages from communication link 420.

When new function instances 408, 410, 412, 414, 416 or 418 are created within local level 400, the system label manager 302 (FIG. 3) sends the unique label and destination address (label) for the function instance 408, 410, 412, 414, 416 or 418 to messaging agent 402 via communication link 420. The messaging agent 402 stores the label along with the destination address (label) of the function instance 408, 410, 412, 414, 416 or 418 in its local look up table 403.

When the messaging agent 402 receives a message addressed to a function instance, either from communication link 420 or any of the function instances 408, 410, 412, 414, 416 or 418, the messaging agent 402 requests a destination address (label) for the function instance from the local repository or look up table 403. Whenever the local look up table 403 returns a destination address (label) that is local, the messaging agent 402 sends the message to the local function instance 408, 410, 412, 414, 416 or 418. As shown, the messaging agent 402 sends the message to messaging queue 404. Thereafter, the dispatcher 406 will retrieve the message from the messaging queue 404 and send it to the appropriate function instance 408, 410, 412, 414, 416 or 418. Whenever the local look up table 403 returns a destination address (label) that is remote, the messaging agent 402 packages the message with the destination address (label) and sends the packaged message to the function instance via communication link 420 and a remote messaging agent that handles messages for the function instance.

Whenever local look up table 403 indicates that the destination address (label) was not found, the messaging agent 402 requests the destination address (label) for the function instance from a remote repository. More specifically, the request is sent to the system label manager 302 (FIG. 3), which obtains the destination address (label) from the system label look up table 304 (FIG. 3). Once the messaging agent 402 receives the destination address (label) from the system label manager 302 (FIG. 3) via the communication link 420, the messaging agent 402 packaging the message with the requested destination address (label) and sends the packaged message to the function instance via communication link 420 and a remote messaging agent that handles messages for the function instance. The messaging agent 402 also stores the received destination address (label) in the local look up table 403.

Now referring to both FIGS. 4 and 5, FIG. 5 depicts a flow chart illustrating the message routing process 500 in accordance with the present invention. The message routing process 500 begins when the messaging agent 402 receives a message in block 502. The message can be received from a remote function instance via remote messaging agents and a communication link 420 or from a local function instance, such as 408, 410, 412, 414, 416 or 418. The messaging agent 402 looks for the destination label for the function instance in block 504 by querying the local repository or look up table 403. If the destination label and corresponding destination address (label) for the function instance to which the message is addressed is found in the local look up table 403, as determined in decision block 506, and the destination address (label) is local, as determined in decision block 508, the messaging agent 402 sends the message to the appropriate messaging queue 404 in block 510 for subsequent delivery to the local function instance, such as 408, 410, 412, 414, 416 or 418 by a dispatcher 406. Thereafter, the process loops back to block 502 where the messaging agent 402 receives the next message.

If, however, the destination address (label) is not local, as determined in decision block 508, the messaging agent 402 packages the message with the destination address (label) for delivery to the destination function instance in block 512. The messaging agent 402 then sends the packaged message to the destination function instance via the backplane of the packet device or communication link 420 and a remote messaging agent that handles messages for the function instance in block 514. Thereafter, the process loops back to block 502 where the messaging agent 402 receives the next message.

If, however, the destination label and corresponding destination address (label) for the function instance to which the message is addressed is not found in the local look up table 403, as determined in decision block 506, the messaging agent 402 requests label information from the system in block 516. More specifically, the request for a destination address (label) for the function instance based on the destination label used in the message is sent to the system label manager 302 (FIG. 3), which obtains the destination address (label) from the system label look up table 304 (FIG. 3). The messaging agent 402 then receives the label information or destination address (label) from the system label manager 302 (FIG. 3) via the communication link 420 and stores the label information in the local look up table 403 in block 518. The messaging agent 402 then packages the message with the destination address (label) for delivery to the destination function instance in block 512. Next, the messaging agent 402 sends the packaged message to the destination function instance via backplane of the packet device or communication link 420 and a remote messaging agent that handles messages for the function instance in block 514. Thereafter, the process loops back to block 502 where the messaging agent 402 receives the next message.

Referring now to FIG. 6, a flow chart illustrating the new function instance creation process 600 in accordance with the present invention is shown. A processing entity creates the new function instance in block 602 and requests a unique label and destination address (label) from the system label manager 302 (FIG. 3) in block 604. Once the processing entity receives the label information, it assigns the label and destination address (label) to the function instance in block 606. The system label manager 302 (FIG. 3) stores the label along with the destination address (label) of the function instance in the system label look up table 304 (FIG. 3) and the messaging agent responsible for handling or routing messages for the function instance stores the label along with the destination address (label) of the function instance in its local look up table in block 608.

The embodiments and examples set forth herein are presented to best explain the present invention and its practical application and to thereby enable those skilled in the art to make and utilize the invention. However, those skilled in the art will recognize that the foregoing description and examples have been presented for the purpose of illustration and example only. The description as set forth is not intended to be exhaustive or to limit the invention to the precise form disclosed. Many modifications and variations are possible in light of the above teaching without departing from the spirit and scope of the following claims.

What is claimed is:

1. A method for routing a message to a function instance comprising the steps of:
receiving the message;
requesting a destination address for the function instance from a local repository;
whenever the destination address is local, sending the message to the function instance;
whenever the destination address is remote, packaging the message with the destination address and sending the packaged message to the function instance; and
whenever the destination address is not found, requesting the destination address for the function instance from a remote repository, packaging the message with the requested destination address and sending the packaged message to the function instance.

2. The method as recited in claim 1, wherein the step of sending the message to the function instance comprises the step of sending the message to a queue for delivery of the message to the function instance via a dispatcher.

3. The method as recited in claim 1, further comprising the step of storing the requested destination address in the local repository whenever the destination address is not found.

4. The method as recited in claim 1, wherein the function instance includes a label and the destination address is requested using the label.

5. The method as recited in claim 1, wherein the local repository and the remote repository are look up tables.

6. The method as recited in claim 1, wherein the local repository and the remote repository are databases.

7. The method as recited in claim 1, wherein the message is received from a local function instance.

8. The method as recited in claim 1, the message is received from a remote function instance.

9. A computer program embodied on a computer readable medium for routing a message to a function instance comprising:
a code segment for receiving the message;
a code segment for requesting a destination address for the function instance from a local repository;
whenever the destination address is local, a code segment for sending the message to the function instance;
whenever the destination address is remote, a code segment for packaging the message with the destination address and a code segment for sending the packaged message to the function instance; and
whenever the destination address is not found, a code segment for requesting the destination address for the function instance from a remote repository, a code segment for packaging the message with the requested destination address and a code segment for sending the packaged message to the function instance.

10. The computer program as recited in claim 9, wherein the code segment for sending the message to the function instance comprises a code segment for sending the message to a queue for delivery of the message to the function instance via a dispatcher.

11. The computer program as recited in claim 9, further comprising a code segment for storing the requested destination address in the local repository whenever the destination address is not found.

12. The computer program as recited in claim 9, wherein the function instance includes a label and the destination address is requested using the label.

13. The computer program as recited in claim 9, wherein the local repository and the remote repository are local look up tables.

14. The computer program as recited in claim 9, wherein the local repository and the remote repository are databases.

15. The computer program as recited in claim 9, wherein the message is received from a local function instance.

16. The computer program as recited in claim 9, the message is received from a remote function instance.

17. An apparatus for routing a message to a function instance comprising:
a local repository;
a messaging agent communicably coupled to the local repository, the messaging agent receiving the message, requesting a destination address for the function instance from the local repository;
whenever the destination address is local, the messaging agent sending the message to the function instance;
whenever the destination address is remote, the messaging agent packaging the message with the destination address and sending the packaged message to the function instance; and
whenever the destination address is not found, the messaging agent requesting the destination address for the function instance from a remote repository, packaging the message with the requested destination address and sending the packaged message to the function instance.

18. The apparatus as recited in claim 17, further comprising:
a queue communicably coupled to the messaging agent;
a dispatcher communicably coupled to the queue; and
the messaging agent sending the message to the function instance by sending the message to the queue for delivery of the message to the function instance via the dispatcher.

19. The apparatus as recited in claim 17, wherein the messaging agent further stores the requested destination address in the local repository whenever the destination address is not found.

20. The apparatus as recited in claim 17, wherein the function instance includes a label and the destination address is requested using the label.

21. The apparatus as recited in claim 17, wherein the local repository and the remote repository are local look up tables.

22. The apparatus as recited in claim 17, wherein the local repository and the remote repository are databases.

23. The apparatus as recited in claim 17, wherein the message is received from a local function instance.

24. The apparatus as recited in claim 17, the message is received from a remote function instance.

25. A system for routing a message to a function instance comprising:
a system label manager;
a system label repository communicably coupled to the system label manager;
one or more messaging agents communicably coupled to the system label manager;
a repository communicably coupled to each of the one or more messaging agents; and
each messaging agent capable of:
receiving the message,
requesting a destination address for the function instance from the repository,
whenever the destination address is local, sending the message to the function instance,
whenever the destination address is remote, packaging the message with the destination address and sending the packaged message to the function instance, and
whenever the destination address is not found, requesting the destination address for the function instance from the system label manager, packaging the message with the requested destination address and sending the packaged message to the function instance.

26. The system as recited in claim 25, further comprising:
a queue communicably coupled to each messaging agent;
a dispatcher communicably coupled to the queue; and
the messaging agent sending the message to the function instance by sending the message to the queue for delivery of the message to the function instance via the dispatcher.

27. The system as recited in claim 25, wherein the messaging agent further stores the requested destination address in the repository whenever the destination address is not found.

28. The system as recited in claim 25, wherein the function instance includes a label and the destination address is requested using the label.

29. The system as recited in claim 25, wherein the repository and the system label repository are look up tables.

30. The system as recited in claim 25, wherein the repository and the system label repository are databases.
